(19) United States
(12) Patent Application Publication
(10) Pub. No.: US 2023/0365043 A1
(43) Pub. Date: Nov. 16, 2023

(54) RETRACTABLE TABLE SYSTEM FOR VEHICLE

(71) Applicant: FAURECIA INTERIEUR INDUSTRIE, Nanterre (FR)

(72) Inventor: Gregory MARTIN, BEAUVAIS (FR)

(21) Appl. No.: 18/143,550

(22) Filed: May 4, 2023

(30) Foreign Application Priority Data
May 13, 2022 (FR) FR 22 04565

(51) Int. Cl. B60N 3/00

(52) U.S. Cl. CPC B60N 3/004

(57) ABSTRACT

A retractable table system that includes a main support for mounting on a trim element of a vehicle, a table having an auxiliary support and a table top supported by the auxiliary support, the auxiliary support being movably mounted on the main support so that the table can move between a retracted position and an extended position of the table, and a storage delimiting a storage space and having an access opening for accessing the storage space, wherein the storage is linked to the table in such a way that the storage space is reduced when the table is in the retracted position and the storage space is increased when the table is in the extended position.

### TECHNICAL FIELD

The present invention relates to the field of vehicle interior layout, in particular motor vehicles, and in particular to a retractable table system for a vehicle.

### BACKGROUND

It is desirable to be able to provide a vehicle interior layout which would be easy to use and provide interesting functions for the user.

### SUMMARY

One of the goals of the invention is to provide a versatile, easy to use retractable table system.

To this end, the invention proposes a retractable table system for a vehicle, comprising a main support intended for being mounted on a trim element of a vehicle, a table having an auxiliary support and a table top supported by the auxiliary support, the auxiliary support being movably mounted on the main support so that the table can move between a retracted position and an extended position of the table, and a storage unit defining a storage space and having an access opening for accessing the storage space, wherein the storage is linked to the table in such a way that the storage space is reduced when the table is in the retracted position and the storage space is increased when the table is in the extended position.

In the extended position of the table, the table top can be used for supporting objects placed on the table top

In the retracted position of the table, the table has a reduced overall size, e.g. by being folded down against the main support and/or against a trim element of the vehicle onto which the main support is attached.

The storage linked to the table so as to increase or to reduce the storage space depending on whether the table is in the retracted position or in the extended position allows the storage and the extension of the table to be combined for an easy use of the retractable table system.

According to particular embodiments, the retractable table system comprises one or a plurality of the following optional features, taken individually or in all technically possible combinations:
the storage comprises a front wall and two side walls, the front wall having an upper edge delimiting the access opening, each lateral wall extending between a lateral edge of the front wall and the main support, the front wall being movable with respect to the main support and linked to the table in such a way that the upper edge is moved towards the main support in the retracted position of the table and away from the main support in the extended position of the table;
both lateral walls can fold and/or extend;
the storage is linked to the table in such a way that the access opening is reduced when the table is in the retracted position and the access opening is increased when the table is in the extended position.
in the retracted position of the table, the table is located in the storage space, and, in the extended position of the table, the table extends outside the storage space;
the table moves from the retracted position to the extended position, and vice versa, through the access opening;
the table top is movably mounted on the auxiliary support or comprises a movable part movably mounted on the auxiliary support;
the table top or the movable part of the table top is movable with respect to the auxiliary support in such a way as to selectively cover the access opening or uncover the access opening;
the table top or the mobile part of the table top is slidably mounted on the auxiliary support.
when the table is in the extended position, the table top or the movable part thereof slides between a retracted position wherein the table top or the movable part thereof is close to the main support and an extended position wherein the table top or the movable part thereof is away from the main support;
the access opening is blocked by the table top when the table is in the extended position and the table top or the movable part thereof is in the retracted position, and/or the access opening is clear when the table is in the extended position and the table top or the movable part thereof in the extended position;
the retractable table system is configured in such a way that in the retracted position of the table, the table top is inclined with respect to a horizontal plane and, in the extended position of the table, the table top extends substantially in the horizontal plane;
the table pivots with respect to the main support between the retracted position and the extended position of the table;
the auxiliary support is mounted on the main support by means of at least one articulated assembly, each articulated assembly comprising a linking rod having a first end linked to the main support by a first pivot link having a first axis of rotation and a second end linked to the auxiliary support by a second pivot link having a second axis of rotation distinct from the first axis of rotation;
the auxiliary support is mounted on the main support by means of at least one sliding assembly, each sliding assembly comprising a guide provided on the main support, the auxiliary support being slidably mounted along the guide.

### BRIEF DESCRIPTION OF THE DRAWINGS

The invention and the advantages of the invention will better understood upon reading the following description, given only as a non-limiting example, and made with reference to the enclosed drawings, wherein:

FIG. 1 is a schematic perspective view of a retractable table system, the table being in the retracted position.

FIG. 2 is a schematic perspective view of the retractable table system shown in FIG. 1, the table being in an intermediate position between the retracted position and an extended position;

FIG. 3 is a schematic perspective view of the retractable table system shown in FIGS. 1 and 2, the table being in the extended position, a table top of the table being in a retracted position;

FIG. 4 is a schematic perspective view of the retractable table system shown in FIGS. 1 to 3, with the table top in an extended position.

### DETAILED DESCRIPTION OF EMBODIMENTS

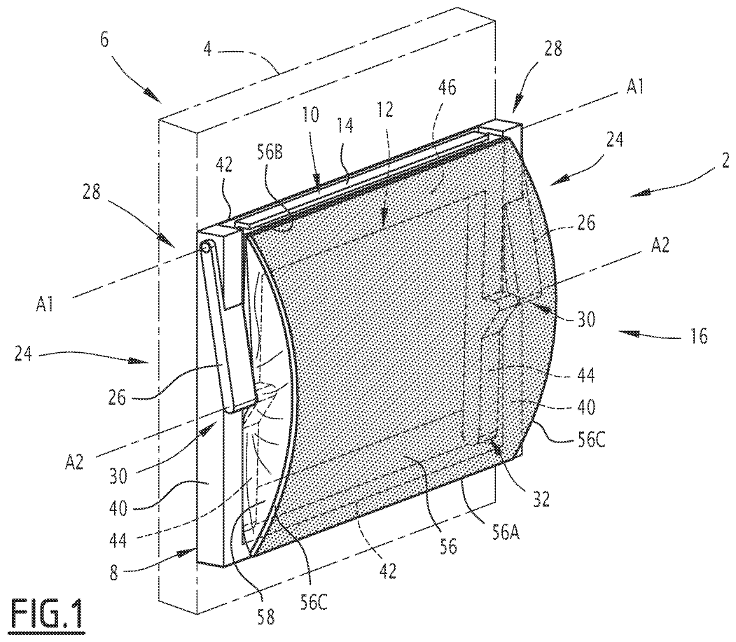

As shown in FIGS. 1 to 4, a retractable table system 2 is mounted on a trim element 4 of a vehicle 6.

The trim element 4 is e.g. a dashboard, a door panel, a seat back or a wall of a luggage compartment, in particular a lateral wall of a luggage compartment.

Hereinafter in the description ,“upper”, “lower”, “vertical” and “horizontal” refer to the retractable table system 2 installed in the vehicle 6.

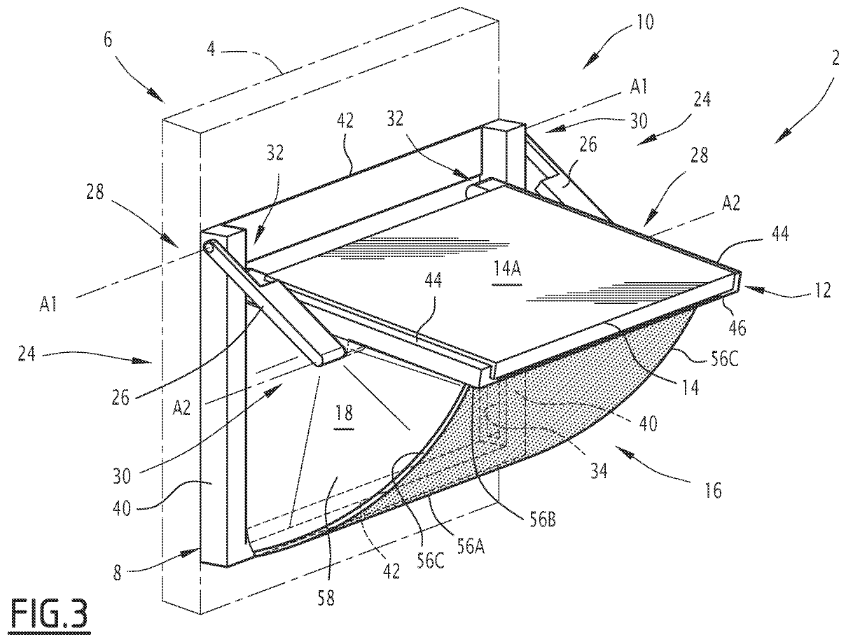

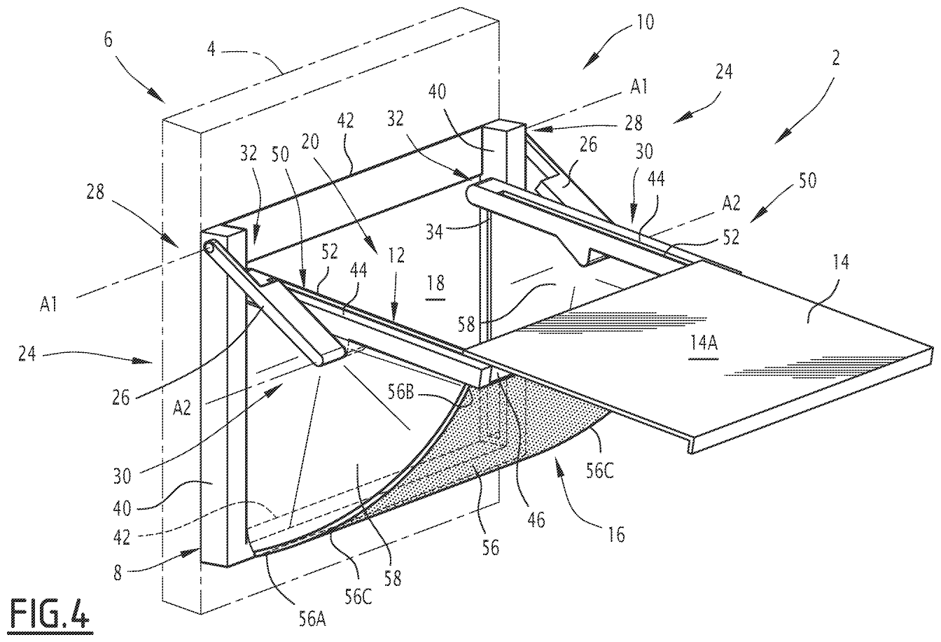

The retractable table system 2 comprises a main support 8 and a table 10 which can move with respect to the main support 8 between a retracted position (FIG. 1) and an extended position (FIGS. 3 and 4).

The table 10 comprises an auxiliary support 12 and a table top 14 supported by the auxiliary support 12.

The auxiliary support 12 is movably mounted on the main support 8 so that the table 10 can move between the retracted position (FIG. 1) and the extended position (FIG. 3).

In the extended position of the table 10, the table top 14 can be used for placing objects on the table top 14, more particularly on an upper surface 14A of the table top 14.

In the extended position of the table 10, the table top 14, or more particularly the upper surface 14A of the table top 14, extends substantially in a horizontal plane.

In the retracted position of the table 10, the table top 14, or more particularly the upper surface 14A of the table top 14, extends along a plane inclined with respect to the horizontal plane, forming a non-zero angle with the horizontal plane. The inclined plane makes e.g. an angle equal to or greater than 60° with the horizontal plane. The inclined plane is e.g. substantially vertical.

Preferentially, in the retracted position of the table 10, the table 10 is brought back against the main support 8 or the trim element 4 on which the main support 8 is attached.

The main support 8 has e.g. the shape of a frame extending in a substantially vertical plane.

The retractable table system 2 comprises a storage 16 delimiting a storage space 18 (FIGS. 3 and 4) and having an access opening 20 (FIG. 4) for accessing the storage space 18.

The storage 16 is linked to the table 10 in such a way that the storage space 18 is reduced when the table 10 is in the retracted position and the storage space 18 is increased when the table 10 is in the extended position.

More precisely, the storage 16 is linked to the table 10 in such a way that the volume of the storage space 18 is reduced when the table 10 is in the retracted position and the volume of the storage space 18 is increased when the table 10 is in the extended position.

The storage space 18, or more precisely the volume thereof, is greater when the table 10 is in the extended position than when the table 10 is in the retracted position.

Preferentially, the storage 16 is linked to the table 10 in such a way that the access opening 20 is selectively reduced (FIG. 1) or increased (FIGS. 3 and 4) depending on whether the table 10 is in the retracted position or in the extended position.

In particular, the storage 16 is linked to the table 10 in such a way that the access opening 20 is reduced when the table 10 is in the retracted position and the access opening 20 is increased when the table is in the extended position.

Preferentially, in the retracted position of the table 10 (FIG. 1), the table 10 is situated in the storage space 18, and, in the extended position of the table 10 (FIGS. 3 and 4), the table 10, and in particular the table top 14, extends outside of storage space 18.

The table 10 advantageously moves from the retracted position (FIG. 1) to the extended position (FIGS. 3 and 4), and vice versa, by moving through the access opening 20 of the storage 16.

In the retracted position of the table 10, the table 10 and the storage 16 have a reduced overall size, and in the extended position of the table, the table 10 and the storage 16 have an increased overall size.

Advantageously, the table top 14 is movably mounted on the auxiliary support 12.

In such case, the table top 14 is e.g. movably mounted on the auxiliary support 12 so as to selectively cover, either partially or completely, the access opening 20 (FIG. 3) or to uncover the access opening 20 (FIG. 4).

The table top 14 is e.g. slidably mounted on the auxiliary support 12.

When the table 10 is in the extended position, the table top 14 is configured for sliding between a retracted position (FIG. 3) wherein the table top partially or completely covers the access opening 20, and an extended position (FIG. 4) wherein the table top 14 uncovers the access opening 20.

The access opening 20 is increased, yet partially or completely covered the table top (14) when the table 10 is in the extended position and the table top 14 is in the retracted position (FIG. 3).

The access opening 20 is increased and uncovered when the table 10 is in the extended position and the table top 14 is in the extended position (FIG. 4).

Preferentially, the table 10 pivots with respect to the main support 8 between the retracted position and the extended position of the table 10.

The auxiliary support 12 is mounted on the main support 8 by means of a mounting mechanism configured so that the table 10 moves from the retracted position to the extended position by moving upwards through the access opening 20 of the storage 16, while pivoting with respect to the main support 8 so that the table top 14 moves from an inclined position, in particular a vertical position, to a horizontal position.

Preferentially, during the movement of the table 10 from the retracted position to the extended position, the auxiliary support 12 and the table top 14 move together by performing a combined rotational and translational movement, in particular a combined rotational and raising movement.

The mounting mechanism comprises e.g. at least one articulated assembly 24, each articulated assembly 24 comprising a linking rod 26 having a first end linked to the main support 8 by a first pivot link 28 having a first axis of rotation A1 and a second end linked to the auxiliary support 12 by a second pivot link 30 having a second axis of rotation A2 distinct from the first axis of rotation A1.

The mounting mechanism comprises e.g. two articulated assemblies 24, the first pivot links 28 of which have the same first axis A1 and the second pivot links 30 of which have the same second axis A2.

In variants, the mounting mechanism comprises only one articulated assembly 24 or more than two articulated assemblies 24 the first pivot links 28 of which have the same first axis A1 and the second pivot links 30 of which have the same second axis A2.

The mounting mechanism comprises e.g. at least one sliding assembly 32, each sliding assembly 32 comprising an elongate guide 34 provided on the main support 8, the auxiliary support 12 being mounted so as to slide along the guide 34.

The auxiliary support 12 supports e.g. a sliding element (not visible), e.g. a peg, mounted to slide along the guide 34. The sliding element is e.g. arranged at one end of the auxiliary support 12 which is in the lower position when the table 10 is in the retracted position.

The auxiliary support 12 is linked to the guide 34 at a distance from the second axis of rotation A2 of each articulated assembly 24.

The guide 34 of each sliding assembly 32 extends e.g. substantially vertically when the main support 8 is mounted on the trim element 4 of the vehicle 6.

The guide 34 of each sliding assembly 32 is e.g. rectilinear. In a variant, the guide 34 of each sliding assembly 32 is curvilinear.

The mounting mechanism comprises e.g. two sliding assemblies 30, the guides 34 of which extend in parallel.

In a variant, the mounting mechanism includes a single sliding assembly 32 or more than two sliding assemblies 32 the guides 34 of which extend in parallel.

The sliding of the auxiliary support 12 with respect to the main support 8 by means of each sliding assembly 32 is accompanied by a rotation of the auxiliary support 12 with respect to the main support 8 due to the presence of each articulated assembly 24.

When the table 10 moves from the retracted position to the extended position, the auxiliary support 12 slides along the guide 34 of the sliding assembly 32, the linking rod 26 of each articulated assembly 24 forcing the rotation of the auxiliary support 12 with respect to the main support 8 together with the sliding.

So, the mounting mechanism combining at least one articulated assembly 24 and at least one sliding assembly 32 allows the table 10 to move with respect to the main support 8 between the retracted position and the extended position upon exiting the storage 16 through the access opening 20 of the slides while pivoting with respect to the main support 8 to bring the table top 14 along a substantially horizontal orientation.

The main support 8 comprises e.g. two parallel uprights 40 spaced apart from each other, each upright 40 carrying a guide 34 of a sliding assembly 32.

The main support 8 has e.g. at least one cross-piece 42 extending transversely between the uprights 40 and linking the uprights together.

The main support 8 comprises e.g. two cross-pieces 42 spaced apart along the uprights 40, in particular a cross-piece 42 connecting lower ends of the uprights 40 and a cross-piece 42 linking upper ends of the uprights 40.

In one example, the linking rod 26 of each articulated assembly 24 has the first end thereof linked to an upright 40 by means of the first associated pivot link 28, in particular linked to the upper end 40A of the upright 40 by means of the first associated pivot link 28.

In particular, the linking rod 26 of each articulated assembly 24A is linked to a respective upright 40 amongst the two uprights 40 of the main support 8.

The auxiliary support 12 comprises e.g. two longitudinal side members 44 which are spaced transversely.

The auxiliary support 12 comprises e.g. at least one transverse element 46 extending transversely between the two side members 44 and linking the side members to each other.

In the retracted position of the table 10, the side members 44 extend e.g. along the uprights 40 of the main support 8.

In the extended position of the table 10, the side members 44 preferentially extend substantially horizontally.

Each side member 44 has a proximal end and a distal end. The proximal end is adjacent to the main support 8 in the extended position of the table 10, and the distal end 44B is away from the main support 8.

Each side member 44 is e.g. linked to the main support 8 by an articulated assembly 24 and by a sliding assembly 32.

The sliding assembly 32 links e.g. the proximal end of the side member 44 to the main support 8, in particular to an upright 40 of the main support 8.

The linking rod 26 of the articulated assembly 24 has the first end thereof linked to the main support 8, in particular to the upright 40 of the main support 8, by the first link 28 and the second end linked to the side member 44 by the second link 30.

The second link 30 is e.g. situated along the side member 44 at a distance from the proximal end, and close to, or preferentially, away from the distal end of the side member 44.

When the table top 14 is slidably mounted on the auxiliary support 12, the table top 14 is e.g. mounted on the auxiliary support 12 by means of at least one guiding assembly 50, each guiding assembly 50 comprising a guiding rail 52 provided on one of the auxiliary support 12 and of the table top 14, the other of the auxiliary support 12 and the table top 14 being guided along the guiding rail 52.

As illustrated in FIG. 4, the guiding rail 52 of each guiding assembly 50 is e.g. carried by the auxiliary support 12, in particular by a side member 44 of the auxiliary support 12. The table top 14 comprises e.g. a guiding element matching (not shown) the guiding rail 52, e.g. a guiding pin.

The table 10 comprises e.g. two guiding assemblies 50, the guiding rail 52 of each guiding assembly 50 being carried by a respective side member 44 of the auxiliary support 12.

The storage 16 comprises e.g. a front wall 56 and two side walls 58 delimiting the storage space 18.

The front wall 56 has a lower edge 56A, an upper edge 56B and two lateral edges 56C, the upper edge 56B delimiting the access opening 20, and each lateral wall 58 extends between a lateral edge 56C of the front wall 56 and the main support 8.

The front wall 56 is movable with respect to the main support 12 and linked to the table 10 in such a way that the upper edge 56B is brought closer to the main support 12 in the retracted position of the table 10 and the access opening 20 is reduced, and that the upper edge 56B is moved away from the main support 8 in the extended position of the table 10, the access opening 20 being increased.

The upper edge 56B of the front wall 56 is e.g. linked to the auxiliary support 12.

The upper edge 56B is e.g. attached to the distal ends 44B of side members 44 of the auxiliary support and/or to a transverse element 46 of the auxiliary support 12 linking the side members 44.

As an alternative, the upper edge 56B is e.g. slidably mounted on the side members 44 of the auxiliary support 12, the upper edge 56B moving towards the distal ends 44B of the side members 44 of the auxiliary support 12 when the table 10 moves from the retracted position to the extended position.

The lower edge 56A of the front wall 56 is attached e.g. to the main support 8, e.g. to a lower cross-piece 42 of the main support 8.

Each lateral wall 58 extends between a lateral edge 56C of the front wall 56 and the main support 8, e.g. between a lateral edge 56C of the front wall 56 and a respective upright 40 of the main support 8.

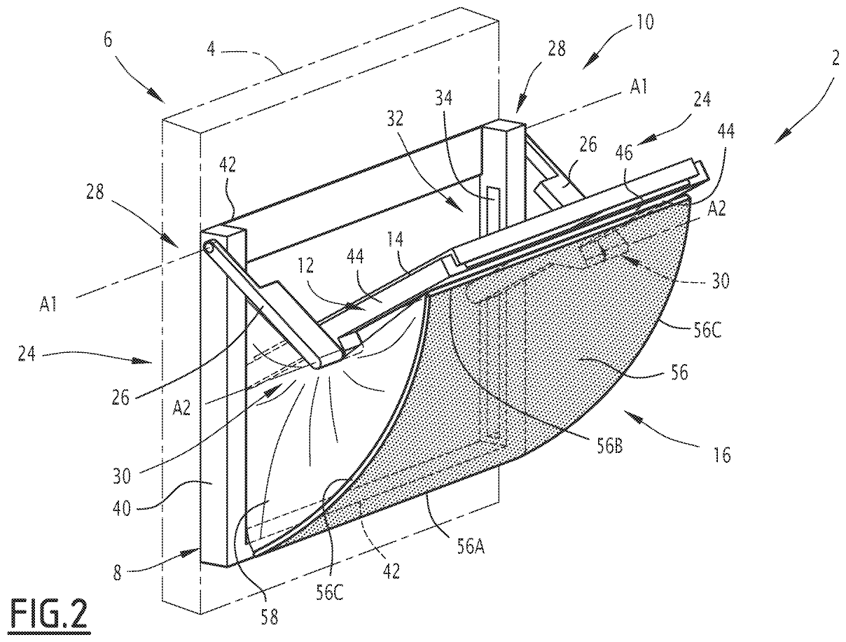

Advantageously, the two side walls 58 can be folded and/or extended. The above allows the side walls 48 to follow the movement of the lateral edges 56C of the front wall 56 accompanying the movement of the table 10, while, if appropriate, allowing each articulated assembly 24 to fold without damaging the side walls 58 (FIGS. 1 and 2).

Preferentially, the table 10 in the retracted position (FIG. 1) is situated behind the front wall 56 of the storage 16. The table 10 is e.g. received between the main support 8 or the trim element 4 and the front wall 56 of the storage 16.

The operation of the retractable table system 2 will be described with reference to FIGS. 1 to 4.

The table 10 is e.g. initially in the retracted position (FIG. 1), the access opening 20 of the storage 16 being reduced. The table 10 is retracted into the storage space 18. The table 10 is situated behind the front wall 56 and masked by the front wall 56. The side members 44 of the auxiliary support 12 extend along the uprights 40 of the main support 8. The upper edge 56B of the front wall 56 is brought close to the main support 8 and the access opening 20 is reduced. The side walls 58 are folded and/or unfolded. In such position, the storage space 18 has a minimum volume.

In order to move the table 10 from the retracted position to the extended position (FIGS. 2 and 3), the table 10 is pulled upwards and pivoted so as to bring the table top 14 into a substantially horizontal position.

The guiding of such combined movement of rotation and raising of the table 10 is guided by each articulated assembly 24 and each sliding assembly 32.

During such movement, the part of the table 10 to which the upper edge 56B of the front wall 56 is linked moves away from the main support 8, which leads to the increasing of the access opening 20.

Moreover, during such movement, the lateral walls 58 unfold and/or extend progressively to accompany the movement of the front wall 56.

In the example shown, once the table 10 is in the extended position, when the table top 14 is in the retracted position (FIG. 3), the increased access opening 20 remains covered, herein substantially completely, by the table top 14. The table top 14 prevents the access to the storage space 18 through the increased access opening 20. In such position, the storage space 18 has a maximum volume.

Once the table 10 is in the extended position, the table top 14 can be slid from the retracted position (FIG. 3) to the extended position (FIG. 4). In this way it is possible e.g. to bring the table top 14 closer to the user.

The sliding of the table top 14 from the retracted position to the extended position makes it possible herein to uncover the access opening 20 in order to give free access to the storage space 18.

The table 10 is brought back from the extended position (FIGS. 3 and 4) to the retracted position (FIG. 1) by folding the table 10 into the storage 16 in a reverse movement to the movement described hereinabove, by first returning, where appropriate, the table top 14 from the extended position (FIG. 3) to the retracted position (FIG. 4).

During such movement, the upper edge 56B of the front wall 56 is brought back towards the main support 8 and the access opening 20 is reduced at the same time as the table 10 is retracted into the storage space 18 via the access opening 20.

The invention is not limited to the embodiments and variants described hereinabove, other examples and variants being conceivable.

The table top 14 does not necessarily completely close the access opening 20 when the table 10 is in the extended position.

In one embodiment, the table top 14 only partially closes the access opening when the table 10 is in the extended position.

Moreover, instead of being slidably mounted on the auxiliary support 12, the table top 14 could be pivotally mounted on the auxiliary support 12, so as to lift the table top 14 in order to give free access to the access opening 20 of the storage 16.

The table top 14 is not necessarily movable, and in particular sliding, as a whole, with respect to the auxiliary support 12.

The table top 14 can be partially movable, and in particular sliding, with respect to the auxiliary support 12.

Thereby, in an example of embodiment, the table top 14 has a part which is attached with respect to the auxiliary support 12 and a part which is movable with respect to the auxiliary support 12, the movement of the mobile part with respect to the auxiliary support 12 making it possible to selectively cover or uncover the access opening 20.

Such a mobile part is e.g. slidably mounted on the auxiliary support 12 or pivotally mounted on the auxiliary support 12.

1. A retractable table system comprising a main support for mounting on a trim element of a vehicle, a table having an auxiliary support and a table top supported by the auxiliary support, the auxiliary support being movably mounted on the main support so that the table can move between a retracted position and an extended position of the table, and a storage delimiting a storage space and having an access opening for accessing the storage space, wherein the storage is linked to the table in such a way that the storage space is reduced when the table is in the retracted position and the storage space is increased when the table is in the extended position.

2. The retractable table system according to claim 1, wherein the storage comprises a front wall and two side walls, the front wall having an upper edge defining the access opening, each lateral wall extending between a lateral edge of the front wall and the main support, the front wall being movable with respect to the main support and linked to the table in such a way that the upper edge thereof is moved towards the main support in the retracted position of the table and away from the main support in the extended position of the table.

3. The retractable table system according to claim 2, wherein the two lateral walls can be folded and/or extended.

4. The retractable table system according to claim 1, wherein the storage is linked to the table in such a way that the access opening is reduced when the table is in the retracted position and the access opening is increased when the table is in the extended position.

5. The retractable table system according to claim 1, wherein in the retracted position of the table, the table is situated in the storage space, and in the extended position of the table, the table extends outside the storage space.

6. The retractable table system according to claim 1, wherein the table moves from the retracted position to the extended position, and vice versa, through the access opening.

7. The retractable table system according to claim 1, wherein the table top is movably mounted on the auxiliary support or comprises a movable portion movably mounted on the auxiliary support.

8. The retractable table system according to claim 7, wherein the table top or the movable part of the table top is movable with respect to the auxiliary support so as to selectively cover the access opening or uncover the access opening.

9. The retractable table system according to claim 1, configured such that, in the retracted position of the table, the table top is inclined with respect to a horizontal plane and, in the extended position of the table, the table top extends substantially in the horizontal plane.

10. The retractable table system according to claim 1, wherein the table pivots with respect to the main support between the retracted position and the extended position of the table.

11. The retractable table system according to claim 1, wherein the auxiliary support is mounted on the main support via at least one articulated assembly, each articulated assembly comprising a linking rod having a first end linked to the main support by a first pivot link having a first axis of rotation and a second end linked to the auxiliary support by a second pivot link having a second axis of rotation distinct from the first axis of rotation.

12. The retractable table system according to claim 1, wherein the auxiliary support is mounted on the main support via at least one sliding assembly, each sliding assembly comprising a guide provided on the main support, the auxiliary support being slidably mounted along the guide.
